(19) United States
(12) Patent Application Publication
(10) Pub. No.: US 2013/0314732 A1
(43) Pub. Date: Nov. 28, 2013

(54) INFORMATION PROCESSING APPARATUS, INFORMATION PROCESSING SYSTEM, AND INFORMATION SENDING METHOD

(71) Applicants: Kei NAKABAYASHI, Kanagawa (JP); Hiroki UCHIBORI, Kanagawa (JP)

(72) Inventors: Kei NAKABAYASHI, Kanagawa (JP); Hiroki UCHIBORI, Kanagawa (JP)

(21) Appl. No.: 13/898,776

(22) Filed: May 21, 2013

(30) Foreign Application Priority Data
May 22, 2012 (JP) 2012-116180

(51) Int. Cl. G06F 3/12

(52) U.S. Cl. CPC G06F 3/1204
USPC 358/1.13

(57) ABSTRACT

An information processing apparatus includes: a request sender configured to send a request for setting information to a setting information providing apparatus via a network, the setting information defining behavior of each one of a plurality of information processing apparatuses; a setting information obtainer to obtain the setting information from the setting information providing apparatus; a setting information storage area to store the obtained setting information; and a setting information sender to send information based on the obtained setting information to at least one other information processing apparatus of the plurality of information processing apparatuses other than the information processing apparatus via a network.

### BACKGROUND OF THE INVENTION

1. Field of the Invention

The disclosures herein generally relate to an information processing apparatus such as an image forming apparatus or a personal computer, an information processing system including multiple information processing apparatuses connected with each other via a network, and a method of sending information to be used for setting at least one information processing apparatus.

2. Description of the Related Art

In recent years, image forming apparatuses became to have multiple functions, which increase the number of setting items that specify behavior of applications implementing the multiple functions. This requires a complex device setting when an image forming apparatus is newly installed or updated, which increases workload of an administrator of the apparatus.

To tackle this problem, information management systems have been proposed to eliminate the necessity of a setting for an individual image forming apparatus. For example, Japanese Laid-open Patent Application No. 2008-72318 discloses a setting information management system in which a server holds setting information for each of the image forming apparatuses, which is obtained from the server by each individual image forming apparatus for installing the setting on itself.

However, there is a problem in the above disclosed information management system in that when multiple image forming apparatuses set their setting information simultaneously, access from the multiple image forming apparatuses is concentrated on the server.

### SUMMARY OF THE INVENTION

It is a general object of at least one embodiment of the invention to provide an information processing apparatus that substantially obviates one or more problems caused by the limitations and disadvantages of the related art. Specifically, it may be desirable to provide an information processing apparatus with which access concentration onto a device that provides setting information can be avoided when multiple information processing apparatuses make requests for obtaining the setting information.

According to at least one embodiment of the invention, an information processing apparatus includes: a request sender configured to send a request for setting information to a setting information providing apparatus via a network, the setting information defining behavior of each one of a plurality of information processing apparatuses; a setting information obtainer to obtain the setting information from the setting information providing apparatus; a setting information storage area to store the obtained setting information; and a setting information sender to send information based on the obtained setting information to at least one other information processing apparatus of the plurality of information processing apparatuses other than the information processing apparatus via a network.

According to at least one embodiment of the invention, it is possible to provide an information processing apparatus with which access concentration onto a device providing setting information can be avoided when multiple information processing apparatuses make requests for obtaining the setting information.

### BRIEF DESCRIPTION OF THE DRAWINGS

FIG. 1 is a schematic view illustrating a configuration of an information processing system according to an embodiment of the invention;

FIG. 2 is a hardware configuration block diagram of an image forming apparatus in the information processing system according to an embodiment of the invention;

FIG. 3 is a module configuration block diagram of an image forming apparatus in the information processing system according to an embodiment of the invention;

FIG. 4 is a schematic view illustrating preference information in the information processing system according to an embodiment of the invention;

FIG. 5 is a basic sequence chart in which a child image forming apparatus obtains preference information from a parent image forming apparatus, then sends the preference information to a grandchild image forming apparatus in the information processing system according to an embodiment of the invention;

FIG. 6 is a sequence chart in which a child image forming apparatus obtains preference information from a parent image forming apparatus, makes a query to a grandchild image forming apparatus for required preference information, then based on the response to the query, extracts the required preference information to send the extracted required preference information to the grandchild image forming apparatus in the information processing system according to an embodiment of the invention;

FIG. 7 is a sequence chart in which a child image forming apparatus obtains preference information from a parent image forming apparatus, makes a query to a grandchild image forming apparatus for required preference information, then based on the response to the query, adds the required preference information to send the added required preference information to the grandchild image forming apparatus in the information processing system according to an embodiment of the invention;

FIG. 8 is a sequence chart in which a child image forming apparatus obtains preference information from a parent image forming apparatus, then sends to the grandchild image forming apparatus only a part of the preference information that is known in advance to be necessary for the grandchild image forming apparatus in the information processing system according to an embodiment of the invention;

FIG. 9 is a sequence chart in which a child image forming apparatus obtains preference information from a parent image forming apparatus, makes a query to a grandchild image forming apparatus for the product type, then based on the response to the query, sends the required preference information to the grandchild image forming apparatus in the information processing system according to an embodiment of the invention;

FIG. 10 is a sequence chart in which a child image forming apparatus obtains preference information from a parent image forming apparatus, then a grandchild image forming apparatus obtains the preference information from the child image forming apparatus in the information processing system according to an embodiment of the invention;

FIG. 11 is a sequence chart in which a child image forming apparatus indicates to a grandchild image forming apparatus that preference information obtained from a parent image forming apparatus has been set, then in response to the indication, the grandchild image forming apparatus obtains the preference information from the child image forming apparatus in the information processing system according to an embodiment of the invention;

FIG. 12 is a sequence chart in which a child image forming apparatus indicates updated items of the preference information at the same time when the child image forming apparatus indicates to a grandchild image forming apparatus that preference information obtained from a parent image forming apparatus has been set in the information processing system according to an embodiment of the invention;

FIG. 13 is a sequence chart in which a child image forming apparatus obtains preference information from a parent image forming apparatus, then after a predetermined time, a grandchild image forming apparatus obtains the preference information from the child image forming apparatus in the information processing system according to an embodiment of the invention; and

FIG. 14 is a sequence chart in which a grandchild image forming apparatus makes a polling on a child image forming apparatus to detect whether preference information is updated, then when updated, the grandchild image forming apparatus obtains the preference information from the child image forming apparatus in the information processing system according to an embodiment of the invention.

### DESCRIPTION OF THE PREFERRED EMBODIMENTS

In the following, embodiments of the invention will be described with reference to the accompanying drawings

<Information Processing System Configuration>

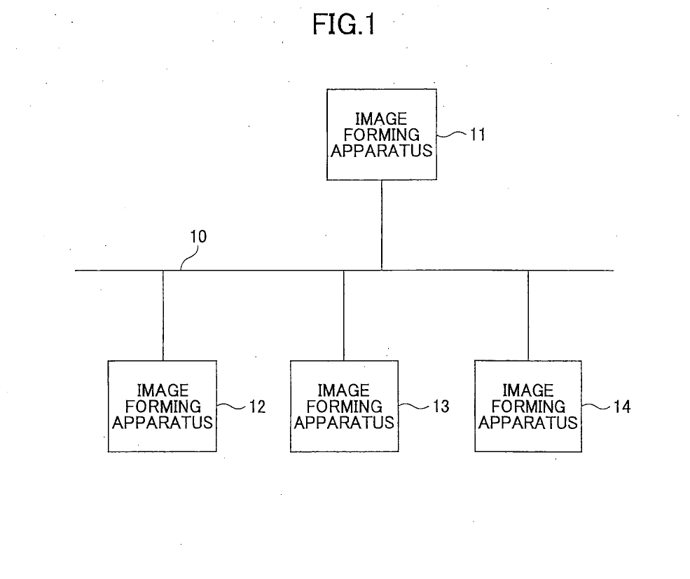

FIG. 1 is a schematic view illustrating a configuration of an information processing system according to the present embodiment of the invention.

As shown in FIG. 1, the information processing system includes multiple (here, four) image forming apparatuses 11-14 connected via a network 10 to communicate with each other.

The image forming apparatus 11 holds preference information, which is one example of setting information specifying behavior of the image forming apparatuses 11-14. The image forming apparatuses 12 and 13 download the preference information held in the image forming apparatus 11 to set the preference information on themselves. The image forming apparatus 13 provides the preference information downloaded from the image forming apparatus 11 to the image forming apparatus 14. Namely, the image forming apparatus 11 corresponds to a setting information providing device, and the image forming apparatuses 12-14 correspond to multiple information processing apparatuses, according to the example embodiment of the invention.

<Hardware Configuration of Image Forming Apparatus>

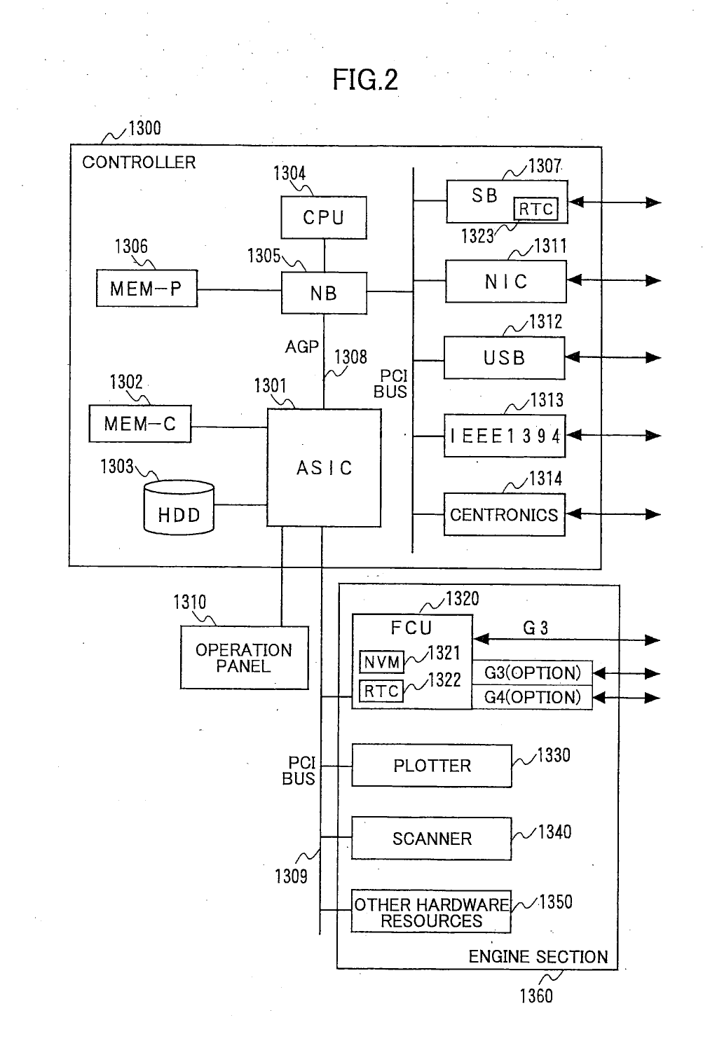

FIG. 2 is a hardware configuration block diagram of the image forming apparatuses 11-14 in FIG. 1 according to the present embodiment of the invention. Here, the image forming apparatuses 11-14 are assumed to be multifunction devices that include functions of a printer, a facsimile machine, a scanner, and a copy machine, and are connectable with a network.

Each of the image forming apparatuses 11-14 is configured with a controller 1300, an engine section 1360, and an operation panel 1310, which are connected with each other via a serial interface 1309 (PCI bus, PCI-X bus, PCI-Express, or the like). The controller 1300 includes an ASIC 1301, a MEM-C 1302, an HDD (hard disk drive) 1303, a CPU 1304, an NB (north bridge) 1305, a MEM-P 1306, an SB (south bridge) 1307, a NIC (network interface controller) 1311, a USB device 1312, an IEEE 1394 device 1313, and a Centronics device 1314. The ASIC 1301 and the NB 1305 are connected with each other via an AGP (Accelerated Graphics Port) 1308.

The ASIC 1301 is an IC for various image processing functions. The MEM-C 1302 is a local memory. The HDD 1303 is a storage area. The CPU 1304 is an IC for various information processing functions. The NB 1305 is a north bridge of the controller 1300. The MEM-P 1306 is a system memory. The SB 1307 is a south bridge of the controller 1300, having a RTC (Real Time Clock) 1323 to measure time to be used for processing in the SB 1307.

The NIC 1311 is a controller for network communication using MAC addresses. The USB device 1312 is a device for providing a connection port compliant with USB standard. The IEEE 1394 device 1313 is a device for providing a connection port compliant with IEEE 1394 standard. The Centronics device 1314 is a device for providing a connection port compliant with Centronics specification.

The operation panel 1310 is hardware including an operation section for a user to make an input, and a display section for a user to obtain an output.

The engine section 1360 includes a FCU (FAX control unit) 1320, a plotter 1330, a scanner 1340, and other hardware resources 1350.

The FCU 1320 includes a non-volatile memory (NVM) 1321 for storing received FAX data, and a RTC 1322 for measuring time to be used for processing in the FCU 1320, and sends/receives FAX data according to G3 standard. The FCU 1320 may include G4 standard functions as well as the G3 standard functions as an option. The plotter 1330 prints data. The scanner 1340 captures an image of a manuscript to generate document data.

<Module Configuration of Image Forming Apparatus>

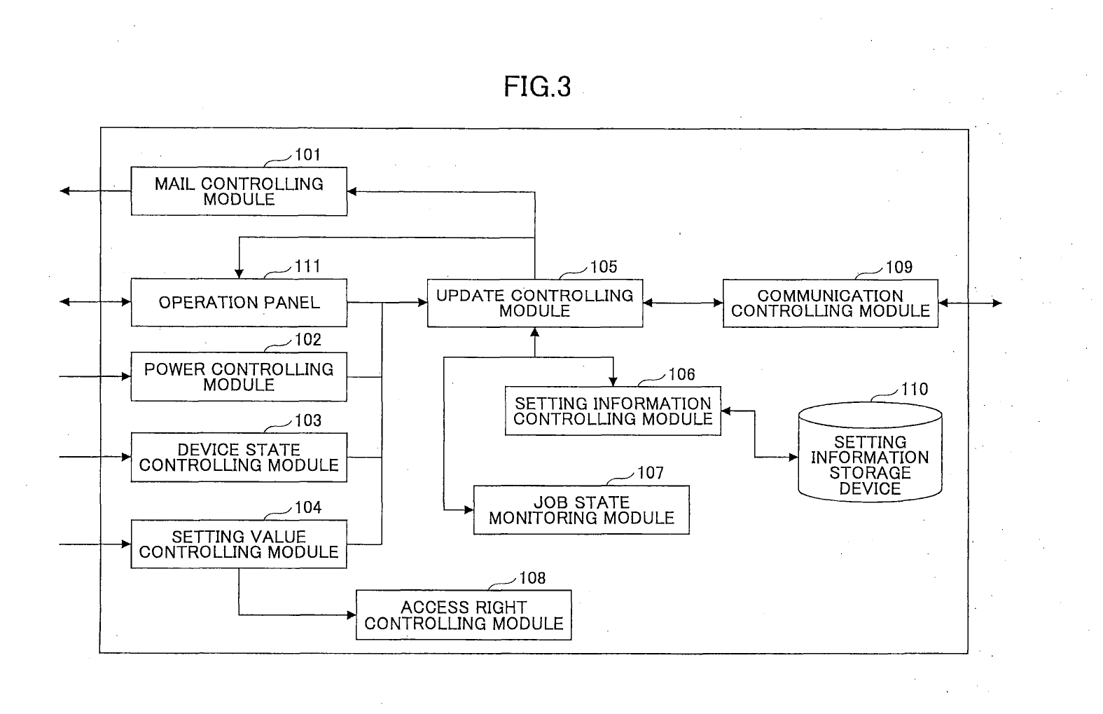

FIG. 3 is a module configuration block diagram of each of the image forming apparatuses 11-14 in the information processing system according to the present embodiment of the invention. These modules are implemented with the hardware shown in FIG. 2 including the controller 1300, and programs stored in the MEM-P 1306, etc.

Each of the image forming apparatuses 11-14 includes: a mail controlling module 101 to control sending mail to a user; a power controlling module 102 to control the power to set on/off; a device state controlling module 103 to control states of devices to indicate an abnormal state to the other modules; a setting value controlling module 104 to control preference information; an update controlling module 105 to update the preference information; a setting information controlling module 106 to set the preference information on the apparatus and to obtain the setting information; a job state monitoring module 107 to indicate states of jobs in the devices to the other modules; an access right controlling module 108 to control access rights; a communication controlling module 109 to control communications with an external device via a network; a setting information storage device 110 to store device settings; and an operation panel module 111 to receive operations from a user and to display outputs on a screen of the operation panel 1310 for a user.

<Example of Preference Information>

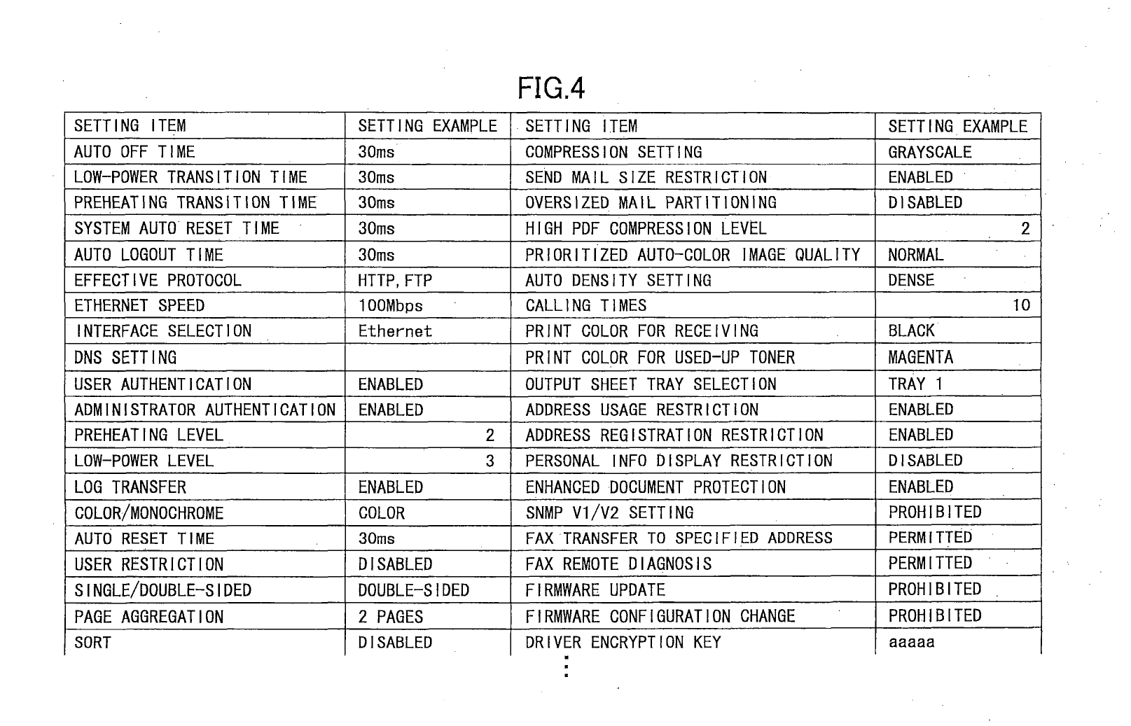

FIG. 4 is a schematic view illustrating preference information in the information processing system according to the present embodiment of the invention. As shown in FIG. 4, the preference information includes setting items and corresponding setting examples of the parameter values. The items shown in FIG. 4 may be managed in a single file, or in multiple files.

<Basic Sequence for Setting Preference Information>

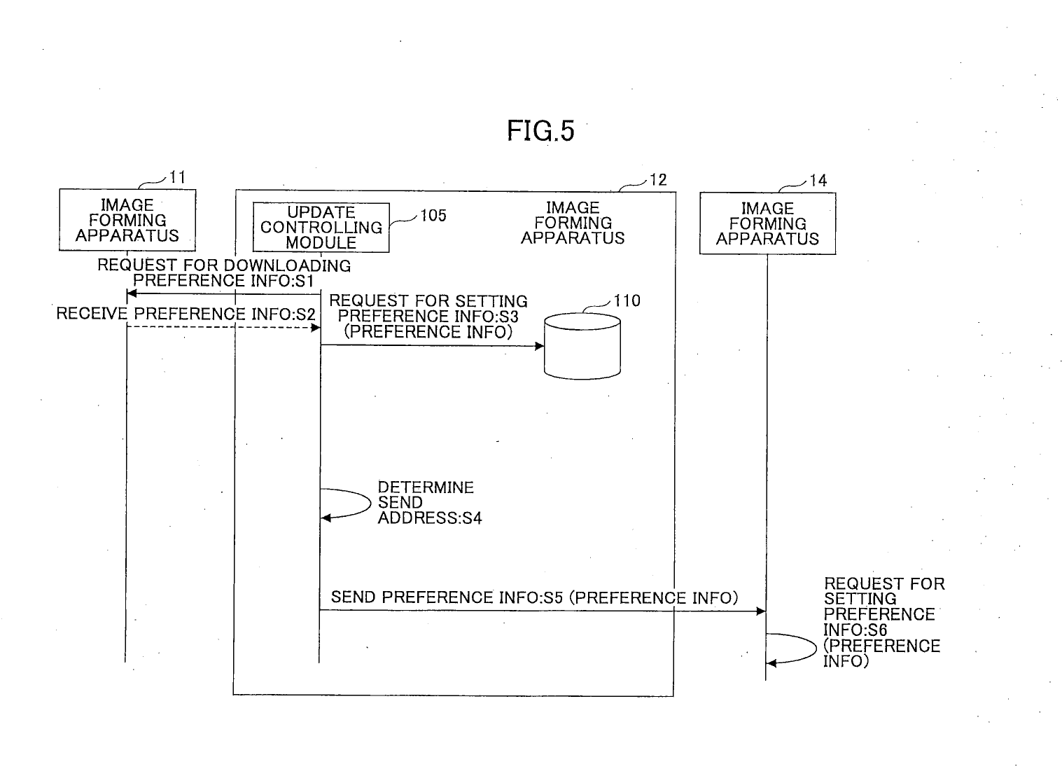

FIG. 5 is a basic sequence chart in which a child image forming apparatus obtains preference information from a parent image forming apparatus, then sends the preference information to a grandchild image forming apparatus in the information processing system according to the present embodiment of the invention. Here, it is assumed that the parent image forming apparatus is the image forming apparatus 11 that holds the preference information; the child image forming apparatus is the image forming apparatus 12 that downloads the preference information from the image forming apparatus 11; and the grandchild image forming apparatus is the image forming apparatus 14 that receives the preference information from the image forming apparatus 12. The same assumption will be applied to the following sequences.

The update controlling module 105 of the image forming apparatus 12 sends a download request for the preference information to the image forming apparatus 11 in response to an import request triggered with an import operation by an administrator, a start-up procedure, a scheduled time, or the like (Step S1), then receives the preference information sent by the image forming apparatus 11 (Step S2).

Next, the update controlling module 105 sends the preference information and the setting request of the preference information to the setting information storage device 110 (Step S3), then the setting information storage device 110 stores the preference information on the image forming apparatus 12.

After that, the update controlling module 105 determines a send address of the preference information (Step S4), then based on the determination result, sends the preference information to the image forming apparatus 14 (Step S5). Here, the send address of the preference information is assumed to be stored in the MEM-P 1306 or the like in advance. The image forming apparatus 14 receives the preference information, then sets it on itself, i.e., the image forming apparatus 14 (Step S6).

According to the sequence shown in FIG. 5, the parent image forming apparatus holds the common preference information to be set on the child image forming apparatus and the grandchild image forming apparatus, which enables the child image forming apparatus to obtain the preference information from the parent image forming apparatus to set the preference information on itself, as well as to send the preference information to the grandchild image forming apparatus, to have the child image forming apparatus and the grandchild image forming apparatus set the same preference information. Therefore, when the same setting information is set on multiple image forming apparatuses, it is possible to prevent access from the multiple image forming apparatuses from being concentrated on a single parent image forming apparatus.

<Sequence in which Preference Information Required for a Grandchild Image Forming Apparatus is Extracted to be Sent>

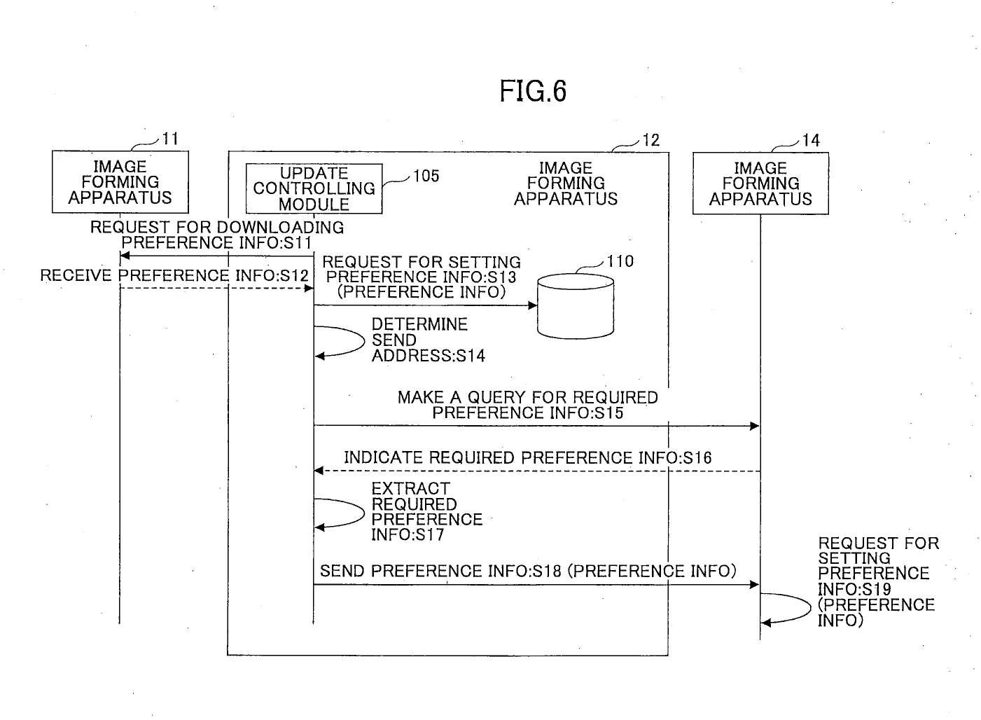

FIG. 6 is a sequence chart in which a child image forming apparatus obtains preference information from a parent image forming apparatus, makes a query to a grandchild image forming apparatus for required preference information, then based on the response to the query, extracts the required preference information to send the extracted required preference information to the grandchild image forming apparatus in the information processing system according to an embodiment of the invention.

Steps S11-S14 in FIG. 6 are the same as Steps S1-S4 in FIG. 5. Next, the update controlling module 105 makes a query for required preference information to the image forming apparatus 14, or the grandchild image forming apparatus (Step S15), then receives data indicating required setting items of the preference information from the image forming apparatus 14 (Step S16).

Next, the update controlling module 105 extracts only the required setting items for the image forming apparatus 14 from the preference information downloaded from the image forming apparatus 11 (parent image forming apparatus) (Step S17), to send the extracted setting items of preference information to the image forming apparatus (Step S18). The image forming apparatus 14 receives the extracted preference information, then sets the extracted preference information on itself (Step S19).

According to the sequence shown in FIG. 6, by having the image forming apparatus 12 (child image forming apparatus) exclude setting items unnecessary for the image forming apparatus 14 (grandchild image forming apparatus), the amount of the preference information to be sent can be made smaller, which reduces workload for communication and setting of the preference information.

<Sequence in which Preference Information Required for a Grandchild Image Forming Apparatus is Added to be Sent>

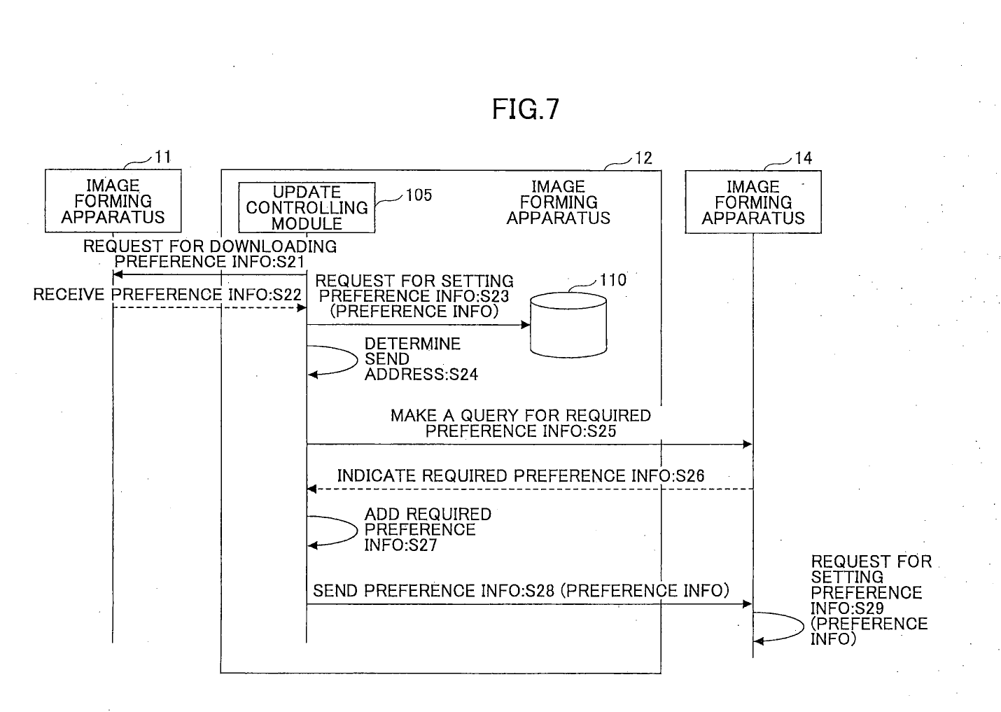

FIG. 7 is a sequence chart in which a child image forming apparatus obtains preference information from a parent image forming apparatus, makes a query to a grandchild image forming apparatus for required preference information, then based on the response to the query, adds the required preference information to send the added required preference information to the grandchild image forming apparatus in the information processing system according to an embodiment of the invention.

Steps S21-S26 in FIG. 7 are the same as S11-S16 in FIG. 6. Next, the update controlling module 105 of the image forming apparatus 12 (child image forming apparatus) adds setting items that are required by the image forming apparatus 14 (grandchild image forming apparatus) but not included in the preference information downloaded from the image forming apparatus 11 (parent image forming apparatus) to the downloaded preference information (Step S27), then sends the added preference information to the image forming apparatus 14 (Step S28). Here, it is assumed that the added setting items of the preference information are held locally by the image forming apparatus 12. The image forming apparatus 14 receives the preference information, then sets the preference information on itself (Step S29).

According to the sequence shown in FIG. 7, setting items of preference information not set on the parent image forming apparatus 11, but set on the child image forming apparatus 12, can be set on the grandchild image forming apparatus 14.

<Sequence in which Preference Information Required for a Grandchild Image Forming Apparatus is Known to a Child Image Forming Apparatus Beforehand>

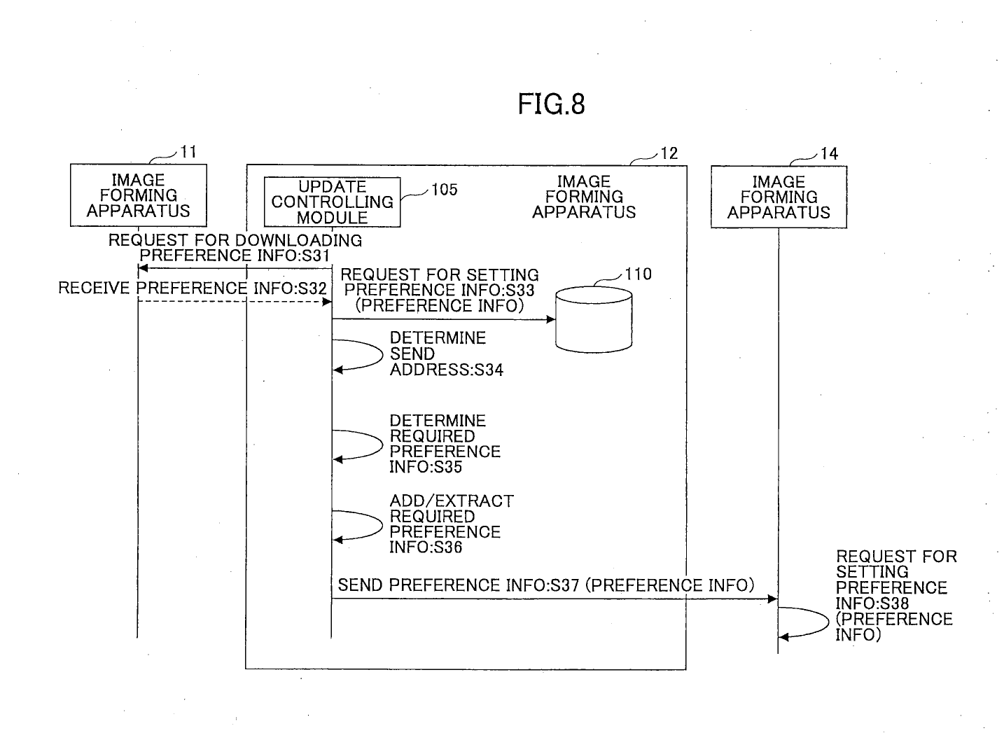

FIG. 8 is a sequence chart in which a child image forming apparatus obtains preference information from a parent image forming apparatus, then sends to the grandchild image forming apparatus only a part of the preference information that is known in advance to be necessary for a grandchild image forming apparatus in the information processing system according to an embodiment of the invention.

Steps S31-S34 in FIG. 8 are the same as S1-S4 in FIG. 5.

Next, the update controlling module 105 determines setting items of preference information required for the image forming apparatus 14 (grandchild image forming apparatus) by referring to data stored beforehand in the MEM-P 1306 or the like (Step S35), then based on the determination result, adds/extracts the required setting items of preference information to/from the preference information downloaded from the image forming apparatus 11 (parent image forming apparatus) (Step S36), to configure (obtain) the preference information only including the setting items required for the image forming apparatus 14.

Next, the update controlling module 105 sends the configured (obtained) preference information to the image forming apparatus 14 (Step S37). The image forming apparatus 14 receives the preference information, then sets the preference information on itself (Step S38).

According to the sequence shown in FIG. 8, a query and a response for the preference information required for the grandchild image forming apparatus are no longer necessary between the child image forming apparatus 12 and the grandchild image forming apparatus 14, which can reduce the amount of communication between the child image forming apparatus 12 and the grandchild image forming apparatus 14.

<Sequence in which a Child Image Forming Apparatus Makes a Query about the Product Type of a Grandchild Image Forming Apparatus, then Based on the Response, Sends the Preference Information>

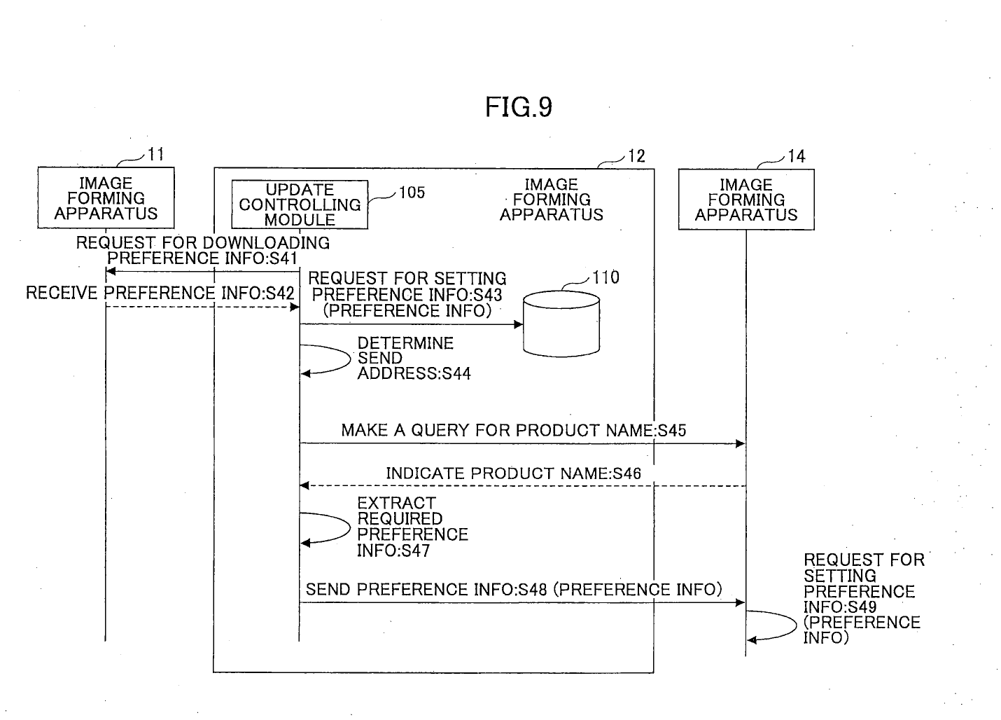

FIG. 9 is a sequence chart in which a child image forming apparatus obtains preference information from a parent image forming apparatus, makes a query to a grandchild image forming apparatus about the product type, then based on the response to the query, sends the required preference information to the grandchild image forming apparatus in the information processing system according to the present embodiment of the invention.

Steps S41-S44 in FIG. 9 are the same as Steps S1-S4 in FIG. 5. Next, the update controlling module 105 makes a query about the product type of the image forming apparatus 14 (grandchild image forming apparatus) (Step S45), then receives data indicating the product type from the image forming apparatus 14 (grandchild image forming apparatus) (Step S46)

Next, the update controlling module 105 extracts setting items required for the image forming apparatus 14 (grandchild image forming apparatus) by referring to data stored beforehand in the MEM-P 1306 or the like that indicates correspondence between the product type and the required preference information (Step S47), then sends the extracted preference information to the image forming apparatus 14 (Step S48). The image forming apparatus 14 receives the preference information, then sets the preference information on itself (Step S49).

According to the sequence shown in FIG. 9, if, for example the image forming apparatus 14 is a product not including a FAX function or a scanner function, the image forming apparatus 12 does not send the preference information about these functions.

Thus, by excluding unnecessary setting items of preference information, the amount of the preference information to be sent can be made smaller, which reduces workload for communication and setting of the preference information.

It is noted that the sequence shown in FIG. 9 is for a case in which the preference information downloaded from the image forming apparatus 11 includes excessive setting items for the image forming apparatus 14. If, on the contrary, the preference information downloaded from the image forming apparatus 11 lacks required setting items for the image forming apparatus 14, the required setting items are added as done at Step S27 in FIG. 7.

<Sequence in which a Grandchild Image Forming Apparatus Autonomously Obtains Preference Information from a Child Image Forming Apparatus>

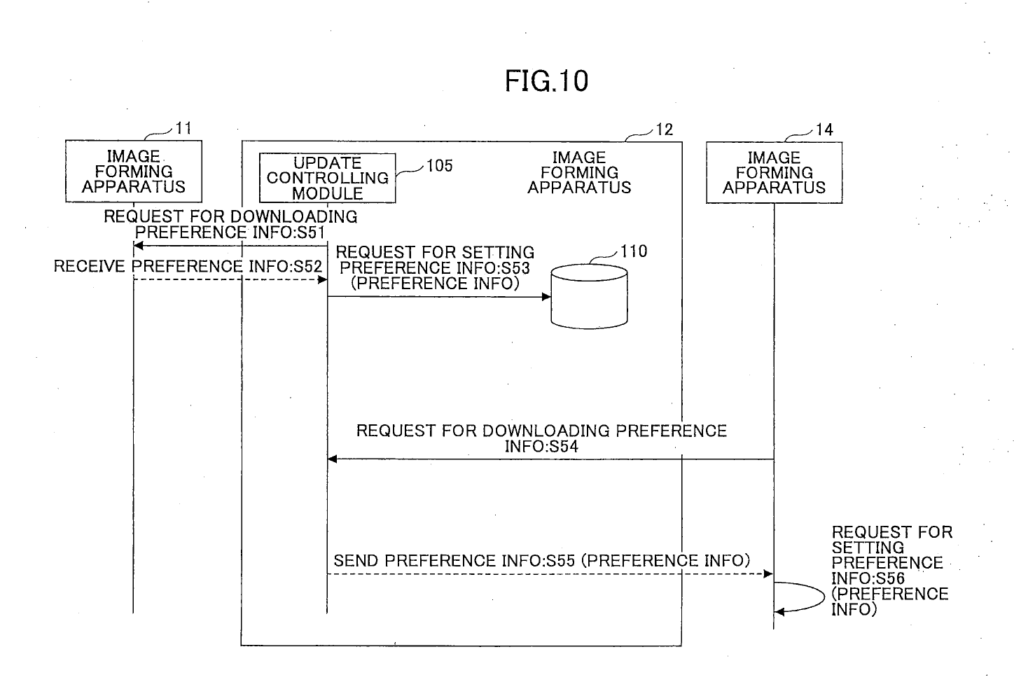

FIG. 10 is a sequence chart in which a child image forming apparatus obtains preference information from a parent image forming apparatus, then a grandchild image forming apparatus obtains the preference information from the child image forming apparatus in the information processing system according to the present embodiment of the invention.

Steps S51-S53 in FIG. 10 are the same as Steps S1-S3 in FIG. 5. After that, the image forming apparatus 14 (grandchild image forming apparatus) sends a download request for preference information of the image forming apparatus 12 (child image forming apparatus) (Step S54), then receives the preference information sent from the image forming apparatus 12 (Step S55). The image forming apparatus 14 receives the preference information, then sets the preference information on itself (Step S56).

Here, Step S54 is executed in response to an import request triggered with an import operation by an administrator of the image forming apparatus 14, a start-up procedure, a scheduled time, or the like, which is executed independently from the downloading of the preference information at the image forming apparatus 12.

<Sequence in which a Grandchild Image Forming Apparatus Downloads Preference Information from a Child Image Forming Apparatus in Response to an Indication of a Setting Completion of the Preference Information from the Child Image Forming Apparatus>

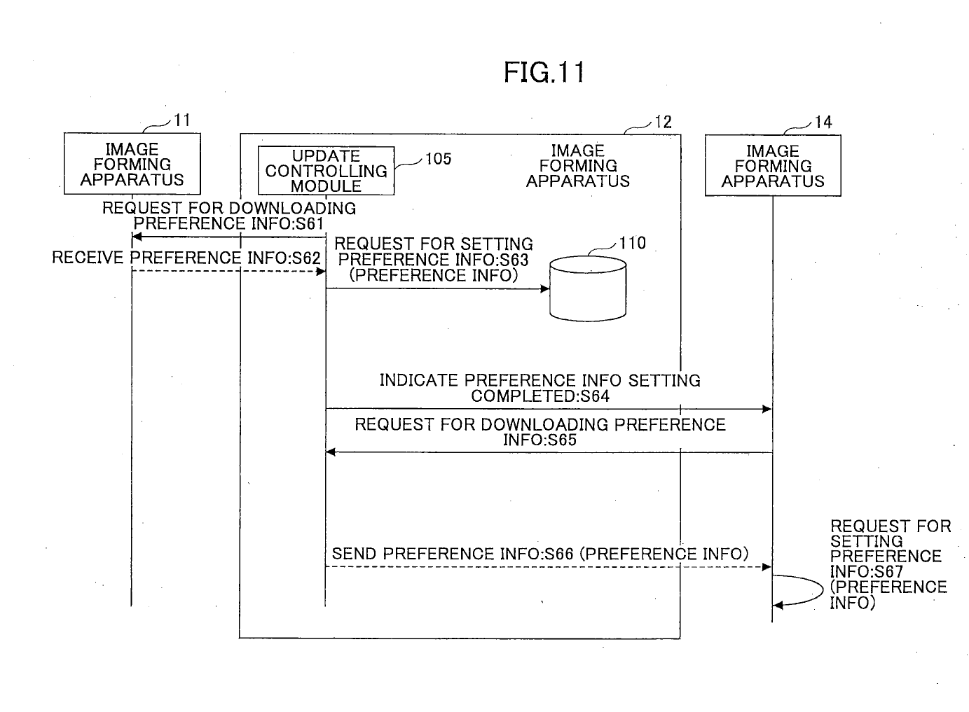

FIG. 11 is a sequence chart in which a child image forming apparatus indicates to a grandchild image forming apparatus that preference information obtained from a parent image forming apparatus has been set, then in response to the indication, the grandchild image forming apparatus obtains the preference information from the child image forming apparatus in the information processing system according to the present embodiment of the invention.

Steps S61-S63 in FIG. 11 are the same as Steps S1-S3 in FIG. 5. Next, the update controlling module 105 of the image forming apparatus 12 (child image forming apparatus) indicates that a setting of the preference information obtained from the image forming apparatus 11 (parent image forming apparatus) has been completed on itself to the image forming apparatus 14 (grandchild image forming apparatus) (Step S64).

In response to the indication from the image forming apparatus 12, the image forming apparatus 14 sends a download request for the preference information to the image forming apparatus 12 (Step S65), then receives the preference information sent from the image forming apparatus 12 (Step S66). The image forming apparatus 14 receives the preference information, then sets the preference information on itself (Step S67).

<Sequence in which a Grandchild Image Forming Apparatus Determines Whether an Update of the Preference Information is Necessary Based on an Update Indication from a Child Image Forming Apparatus, then Based on the Determination Result, Downloads the Preference Information from the Child Image Forming Apparatus>

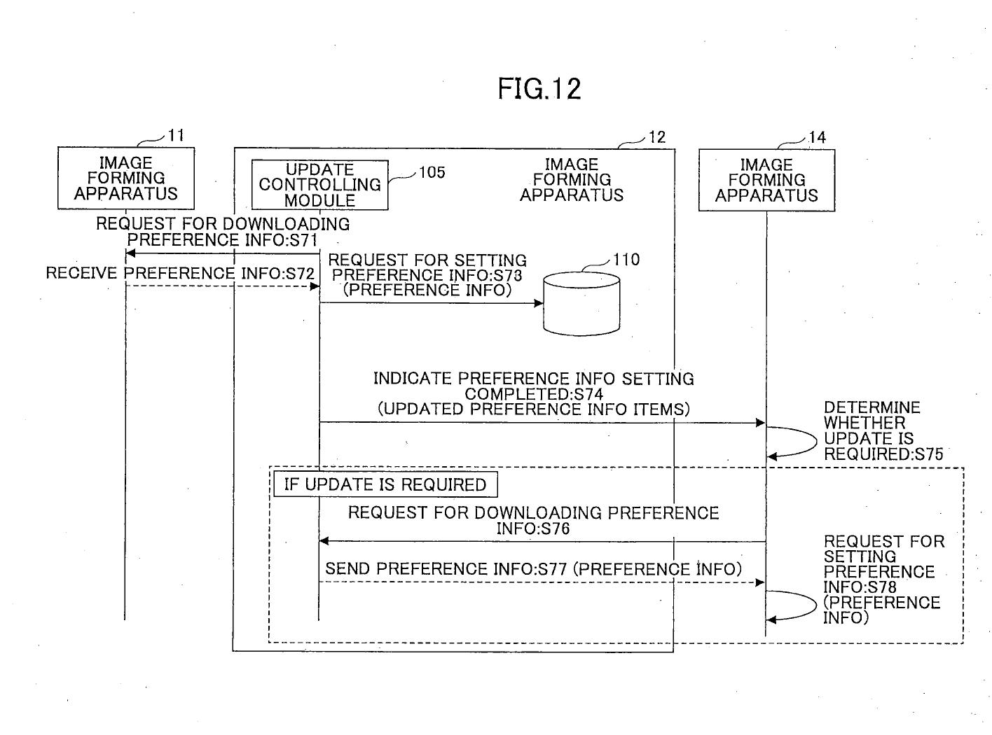

FIG. 12 is a sequence chart in which a child image forming apparatus indicates updated items of the preference information at the same time when the child image forming apparatus indicates to a grandchild image forming apparatus that preference information obtained from a parent image forming apparatus has been set in the information processing system according to an embodiment of the invention.

Steps S71-S73 in FIG. 12 are the same as Steps S1-S3 in FIG. 5. Next, the update controlling module 105 of the image forming apparatus 12 (child image forming apparatus) indicates that a setting of the preference information obtained from the image forming apparatus 11 (parent image forming apparatus) has been completed on itself to the image forming apparatus 14 (grandchild image forming apparatus) along with the set (updated) setting items of preference information (Step S74).

Receiving the indication, the image forming apparatus 14 determines whether an update of the preference information on itself is necessary by referring to the updated setting items of preference information (Step S75). If determining that a setting is necessary, the image forming apparatus 14 sends a download request for the preference information to the image forming apparatus 12 (child image forming apparatus) (Step S76), then receives the preference information sent from the image forming apparatus 12 (Step S77). The image forming apparatus 14 receives the preference information, then sets the preference information on itself (Step S78). If determining that a setting is not necessary, no operation is taken.

According to the sequence shown in FIG. 12, an unnecessary download of preference information can be avoided if an update of preference information is unnecessary.

<Sequence in which a Grandchild Image Forming Apparatus Obtains Preference Information from a Child Image Forming Apparatus after a Predetermined Time has Passed Since the Child Image Forming Apparatus Obtained the Preference Information from a Parent Image Forming Apparatus>

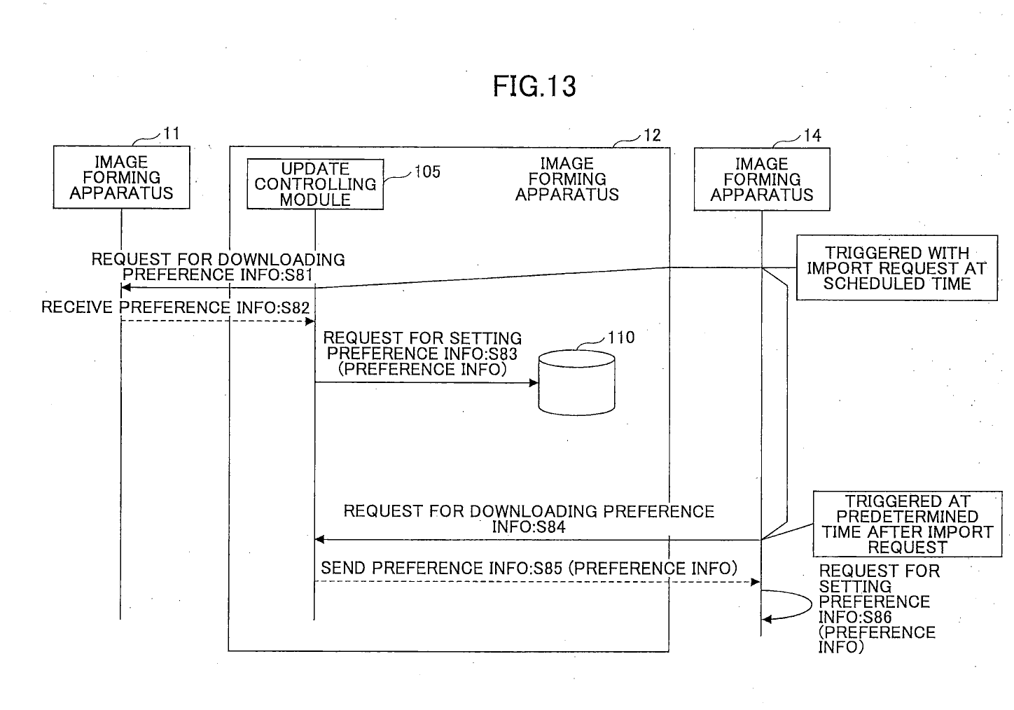

FIG. 13 is a sequence chart in which a child image forming apparatus obtains preference information from a parent image forming apparatus, then after a predetermined time, a grandchild image forming apparatus obtains the preference information from the child image forming apparatus in the information processing system according to the present embodiment of the invention.

Steps S81-S83 in FIG. 13 are the same as Steps S1-S3 in FIG. 5, except that Step S81 is triggered by an import request at a scheduled time. The image forming apparatus 14 (grandchild image forming apparatus) sends a download request for the preference information to the image forming apparatus (child image forming apparatus), after a certain amount of time has passed since Step S81 was executed (Step S84), then receives the preference information sent from the image forming apparatus 12 (Step S85). The image forming apparatus 14 receives the preference information, then sets the preference information on itself (Step S86).

According to the sequence shown in FIG. 13, it is possible to avoid an overlap of a timing when a child image forming apparatus obtains preference information from a parent image forming apparatus, and a timing when a grandchild image forming apparatus obtains preference information from the child image forming apparatus.

<Sequence in which a Grandchild Image Forming Apparatus Makes a Polling on a Child Image Forming Apparatus to Detect Whether Preference Information is Updated, and if so, to Obtain the Preference Information from the Child Image Forming Apparatus>

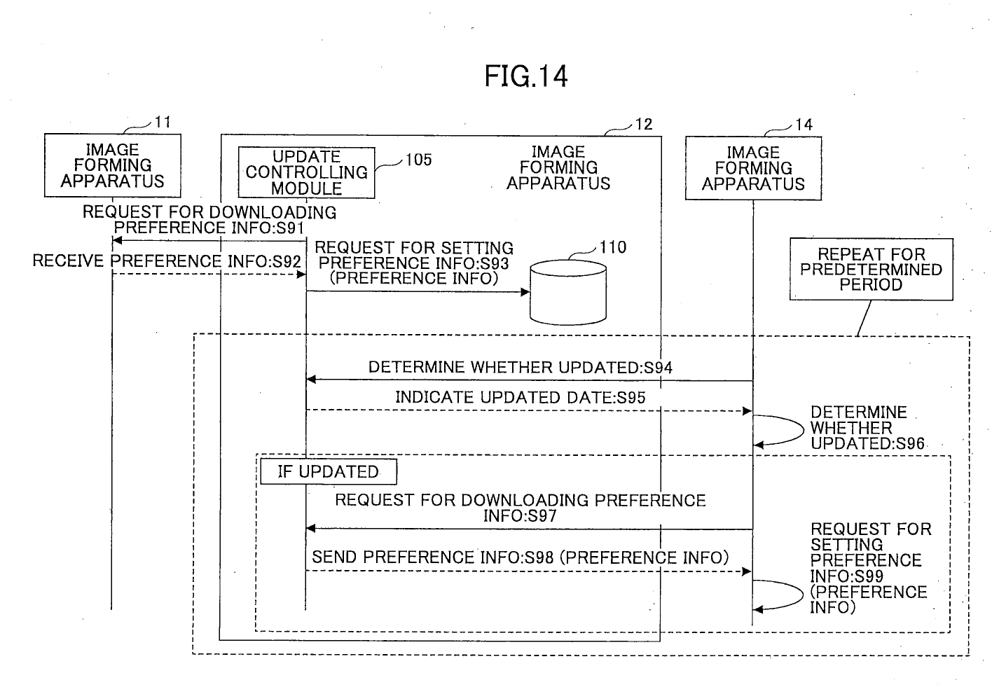

FIG. 14 is a sequence chart in which a grandchild image forming apparatus makes a polling on a child image forming apparatus to detect whether preference information is updated, then when updated, the grandchild image forming apparatus obtains the preference information from the child image forming apparatus in the information processing system according to the present embodiment of the invention.

Steps S91-S93 in FIG. 14 are the same as Steps S1-S3 in FIG. 5. The image forming apparatus (grandchild image forming apparatus) makes a polling on the image forming apparatus 12 (child image forming apparatus) to determine whether the preference information has been updated (Step S94), then receives information on the update date from the image forming apparatus 12 (Step S95).

The image forming apparatus 14 determines whether an update on itself is necessary by referring to the update date on the image forming apparatus 12 and the last update date on itself (Step S96). If determining that the update is necessary, the image forming apparatus 14 sends a download request for the preference information to the image forming apparatus (child image forming apparatus) (Step S97), then receives the preference information sent from the image forming apparatus 12 (Step S98). The image forming apparatus 14 receives the preference information, then sets the preference information on itself (Step S99). If determining that the update is not necessary, no operation is taken.

Steps S94-S99 are repeated for a predetermined period. According to the sequence shown in FIG. 14, an unnecessary download of preference information can be avoided if an update of preference information is unnecessary.

The present invention has been described as above with preferred embodiments. The present invention, however, is not limited to these embodiments, but various variations and modifications may be made without departing from the scope of the present invention.

In one example, the present invention may reside in an information processing apparatus including: an information obtaining section to obtain setting information from a setting information providing device via a network, the setting information being to be set on multiple of the information processing apparatuses, the setting information providing device holding the setting information; an information setting section to set the obtained setting information on the information processing apparatus; and an information sending section to send the obtained setting information to the other multiple information processing apparatuses.

In one example, the information processing apparatus further includes: a data obtaining section to obtain data indicating setting information required for each of the other multiple information processing apparatuses; and a required information obtaining section to obtain the setting information required for each of the other multiple information processing apparatuses based on the data obtained with the data obtaining section. The information sending section sends the setting information obtained with the required information obtaining section.

In one example, the required information obtaining section has a section to remove unnecessary information for each of the other multiple information processing apparatuses if the setting information obtained with the required information obtaining section includes the unnecessary information.

In one example, in the information processing apparatus, the required information obtaining section has a section to add necessary information for each of the other multiple information processing apparatuses if the setting information obtained with the required information obtaining section does not include the necessary information.

In one example, the information processing apparatus further includes: a data obtaining section to obtain data indicating a product type for each of the other multiple information processing apparatuses; and a required information obtaining section to obtain the setting information required for each of the other multiple information processing apparatuses based on the data obtained with the data obtaining section. The information sending section sends the setting information obtained with the required information obtaining section.

In one example, an information processing system includes: multiple information processing apparatuses; and a setting information providing device connected with the multiple information processing apparatuses via a network, and holding setting information being to be set on the multiple information processing apparatuses. At least one information processing apparatus of the information processing apparatuses includes an information obtaining section to obtain the setting information from the setting information providing device via the network, an information setting section to set the obtained setting information on the information processing apparatus, and an information sending section to send the obtained setting information to the other multiple information processing apparatuses.

In one example, in the information processing system, each of the multiple information processing apparatuses and the setting information providing device has an image forming function.

In the information processing system, at least the one information processing apparatus of the multiple information processing apparatuses has an indicating section to indicate that the one information processing apparatus has completed a setting of the setting information obtained from the setting information providing device on the one information processing apparatus, then based on the indication, each of the other information processing apparatuses makes a request for sending the setting information to the one information processing apparatus.

In the information processing system, the indicating section also indicates setting items of the setting information that has been completed to be set, then based on the indicated setting items of the setting information, each of the other information processing apparatuses determines whether to make the request for sending the setting information.

In the information processing system, the indicating section gives an indication in response to a query from one of the other information processing apparatuses.

In one example, the present invention may reside in a non-transitory computer-readable recording medium having a program stored therein for causing a computer to execute a method of information processing, the program including: obtaining setting information from a setting information providing device via a network, the setting information being to be set on multiple information processing apparatuses, the setting information providing device holding the setting information; setting the obtained setting information on one of the information processing apparatuses; and sending the obtained setting information to the other information processing apparatuses.

The present application is based on Japanese Priority Application NO. 2012-116180 filed on May 22, 2012, with the Japanese Patent Office, the entire contents of which are hereby incorporated by reference.

What is claimed is:

1. An information processing apparatus, comprising:
a request sender configured to send a request for setting information to a setting information providing apparatus via a network, the setting information defining behavior of each one of a plurality of information processing apparatuses;
a setting information obtainer to obtain the setting information from the setting information providing apparatus;
a setting information storage area to store the obtained setting information; and
a setting information sender to send information based on the obtained setting information to at least one other information processing apparatus of the plurality of information processing apparatuses other than the information processing apparatus via a network.

2. The information processing apparatus of claim 1, further comprising:
a data obtainer to obtain, from the other information processing apparatus, data indicating required setting information required for the other information processing apparatus; and
a required information obtainer to obtain the required setting information based on the data indicating required setting information,
wherein the setting information sender sends the required setting information to the other information processing apparatus, as the information based on the obtained setting information.

3. The information processing apparatus of claim 2, wherein the required information obtainer extracts the required setting information from the obtained setting information obtained from the setting information providing apparatus based on the data indicating required setting information.

4. The information processing apparatus of claim 2, wherein the required information obtainer removes a part of the setting information from the obtained setting information obtained from the setting information providing apparatus, to obtain the required setting information.

5. The information processing apparatus of claim 2, wherein the required information obtainer adds additional setting information to the obtained setting information, when the obtained setting information does not include the required setting information based on the data indicating required setting information.

6. The information processing apparatus of claim 2, further comprising:
a product type data obtainer configured to obtain product type data indicating a product type of the other information processing apparatus,
wherein the required setting information is determined based on the product type data.

7. The information processing apparatus of claim 1, wherein the setting information sender automatically sends the information based on the obtained setting information to the other information processing apparatus.

8. The information processing apparatus of claim 1, wherein the setting information sender sends the information based on the obtained setting information to the other information processing apparatus in response to a request received from the other information processing apparatus.

9. The information processing apparatus of claim 8, wherein:
the setting information sender further sends information indicating that the setting information is stored at the information processing apparatus, to the other information processing apparatus, and
the request from the other information processing apparatus is sent based on the information indicating that the setting information is stored.

10. The information processing apparatus of claim 9, wherein:
the setting information sender further sends information indicating one or more items of the setting information that are set at the information processing apparatus, to the other information processing apparatus, and
the request from the other information processing apparatus is determined to be sent based on the information indicating one or more items of the setting information that are set.

11. The information processing apparatus of claim 1, wherein
the setting information obtainer sends a request for setting information to the setting information providing apparatus, based on a request from the other information processing apparatus.

12. The information processing apparatus of claim 8, wherein the setting information sender sends the information based on the setting information, in a predetermined time period counted from the time when the request from the other information processing apparatus is sent.

13. An information processing system, comprising:
a setting information providing apparatus configured to store setting information, the setting information defining behavior of each one of a plurality of information processing apparatuses; and
at least one second information processing apparatus configured to send a request for setting information to the setting information providing apparatus via a network, obtain the setting information from the setting information providing apparatus, store the obtained setting information, and send information based on the obtained setting information to at least one third information processing apparatus via a network.

14. The information processing system of claim 13, further comprising:
the at least one third information processing apparatus configured to store the information based on the obtained setting information, received from the at least one second information processing apparatus.

15. The information processing system of claim 14, wherein each one of the plurality of information processing apparatuses is an image forming apparatus.

16. A method of sending information based on setting information obtained from a setting information providing apparatus, respectively, to at least one other information processing apparatus, performed by an information processing apparatus, the method comprising:
sending a request for setting information to the setting information providing apparatus via a network, the setting information defining behavior of each one of a plurality of information providing apparatus including the information processing apparatus and the at least one other information processing apparatus;
obtaining the setting information from the setting information providing apparatus;
storing the obtained setting information in a memory of the information processing apparatus; and
sending the information based on the obtained setting information to the at least one other information processing apparatus of the plurality of information processing apparatuses other than the information processing apparatus.

17. The information sending method of claim 16, further comprising:
obtaining, from the other information processing apparatus, data indicating required setting information required for the other information processing apparatus; and
obtaining the required setting information based on the data indicating required setting information,
wherein the information based on the obtained setting information that is sent to the other information processing apparatus includes the required setting information.

18. The information setting method of claim 16, further comprising:
receiving a request from the other information processing apparatus, wherein the information based on the obtained setting information is sent in response to the request.

19. The information setting method of claim 18, further comprising:
sending information indicating that the setting information is stored at the information processing apparatus, to the other information processing apparatus, wherein the request from the other information processing apparatus is sent based on the information indicating that the setting information is stored.

20. The information setting method of claim 18, further comprising:
sending information indicating one or more items of the setting information that are set at the information processing apparatus, to the other information processing apparatus, wherein the request from the other information processing apparatus is determined to be sent based on the information indicating one or more items of the setting information that are set.
